(19) United States
(12) Patent Application Publication
(10) Pub. No.: US 2016/0321656 A1
(43) Pub. Date: Nov. 3, 2016

(54) METHOD AND SYSTEM FOR PROTECTING INFORMATION AGAINST UNAUTHORIZED USE (VARIANTS)

(71) Applicant: ILYA SAMUILOVICH RABINOVICH, Kximki (RU)

(72) Inventor: ILYA SAMUILOVICH RABINOVICH, Kximki (RU)

(21) Appl. No.: 15/026,967

(22) PCT Filed: Nov. 5, 2014
(86) PCT No.: PCT/RU2014/000833

§ 371 Date: Jul. 13, 2016

(30) Foreign Application Priority Data
Nov. 1, 2013 (RU) 2013149120

(51) Int. Cl. G06Q 20/38; H04L 9/32; H04W 12/06; H04L 29/06

(52) U.S. Cl. CPC G06Q 20/3829; H04L 63/06; H04L 63/0861; H04L 9/3236; H04W 12/06; H04L 2209/80; H04L 2209/56; G06Q 2220/00

(57) ABSTRACT

The given invention refers to ways of information protection from unsanctioned use. Method of creating of a safe environment for protecting information from unsanctioned use is characterized by encrypting information with a cryptographic processor and a closed cryptographic key, stored in the use's device, by forming and sending the data package, containing single-use authentication code of the user, to the aiding person's server, decrypting data package at the aiding person's server, and checking at the server of the single-use authentication code and test code, and, in case of positive result of verification server sends to the user a data package, single-use code of user authentication, received during decrypting the user's data package, after which the user's device forms a new data package, characterized by a new single-use code of user authentication, also data package consists of encrypted and non-encrypted parts, and the non-encrypted part contains a verification code, made with an ability to check the data package integrity and user identifier,

### BACKGROUND OF THE INVENTION

This invention relates to methods of safe information transfer and protecting that information from unsanctioned use.

There are various methods and devices used to heighten reliability of information transfer and protection from unsanctioned use. There is a known way of doing a multi factor strong authentication of a bank card holder using a mobile phone in the area of mobile connection while making interbank financial transactions in the international pay system by the specification protocol 3-D Secure (others) and the system which controls it (patent of RF No 2301449, published on 20 Jun. 2007), in which while the interbank financial transaction in the international pay system by the specification protocol 3-D Secure is being done, there is a four phase sequence of that transaction with a condition of many factor strong authentication of the client using mobile phone in the mobile connection area: operation initiation; generating and getting authentic request; generating and receiving the answer to the authentication request; completing the operation, generating and giving the notice about the result of the operation. While accomplishing each phase there are messages signals transfer between system members using specification components of 3-D Secure.

The drawback of this method is a low level of security of the financial transactions, due to insufficient safety of the client's mobile phone from attackers, who could use the mobile channel of communication existing between the user and the bank. Such attacks could be accomplished in different ways.

Firstly, Trojan program could intercept a personal password of the user and use it as an authentication code of the illegal transaction. Secondly, Trojan program could change the address and sum of payment, hiding the changes from the user, after that the user will confirm such payment with his own password. Thirdly, if the attacker using means of social engineering manages to get the phone number of the user from the user, that number which is connected to his or her bank card, the attacker will have an opportunity to doubling user's sim-card and further illegal cashing money from said account.

There also is a way of securing safety of mobile financial transactions in the networks of mobile communication and the system for it's implementation (patent of RF No 2446467, published on 27 Mar. 2012). What is done—initiating the connection of the client to the aforementioned service in the mobile pay system, for that he is authorized and identified in the mobile pay system using public identifier in the net, then register the client's details in the database of the mobile pay service provider's information system and give the client the activation code through the communication channels, then register the client's pay instrument (banking account, or card account, or an account in a non-banking office) through transferring a minimally required number of parameters to the mobile pay system's provider—to make a disconnected pay operation with the participation of the client.

Those parameters are stored by the mobile pay system operator, they initiate the accomplishing of the mobile financial transaction, in case if that transaction is initiated by the client, are formed with the means of the client's mobile phone, containing the parameters of the financial transaction and pay instrument, which are transferred to the operator through the communication channels, authenticating the client using one authentication factor, completing that financial transaction using the details of the client's pay instrument and transfer the information about the transaction to the client through the operator's channels.

In case if accomplishing that mobile financial transaction is initiated by the trade-service company, a payment offer is created with the help of the innovative-technical means, and send it to the mobile pay system operator, who identifies the client and transfers the message-demand, containing the authentication demand and pay offer, using the client's mobile devise a signal with the information is formed, information containing that financial operation parameters and the pay instrument, and through the communication channels transfer it to the operator of the mobile pay system, authenticating the client using one authenticating factor, make the financial transaction using client's pay details and transfer to the client through the operator's channels information about the results of the accomplished financial transaction, then with the means of the client's mobile device demand is formed to turning off the pay instrument and transfer through the communication channels to the mobile pay system's operator, who does the client authentication using one authentication factor, and, on the basis of the demand in the mobile operator's information system's database, turn off the pay instrument, give the client information about the turning off of the instrument, form the demand for turning off the mobile pay system service with the client's mobile device, make authorization and identify in the mobile pay system using public identifier in the net, change the client's status by blocking the account in the provider's information system database and the signal with the information about turning off the services of the mobile pay system through the operator's communication channels is given to the client.

The disadvantage of this method is that the connection with the subscriber is made so that it does not exclude the possibility of an attacker getting into the communication channel between the client and the bank. So, like in afore mentioned analogue, the attacker has an opportunity to change the banking app with a harmful one, and also cloning the sim-card to further use it to cash the money from the user's account.

The closest analogue for this method is a way of identification and authentication of the user (patent of RF No 2469391, published on 10 Dec. 2012), where the information is coded with the help of a processor and the closed cryptographic key, stored in the user's device, data package, encrypted, is formed, which contains information, related to the given service, a single-use user authentication code, user identifier, checking code, made with a possibility of checking the wholeness of the data package, then the encrypted data package is sent to the server of the person supervising it, then the data package is decrypted on the server of that person, then it checks a single-use authentication code of the user and the checking code and makes a decision about authenticating the user on the analyses of the results.

Using this method allows to heighten the user authentication reliability after the single-use authentication code is checked on the server. Apart from that, user identification reliability in the nearest analogue is higher thanks to the fact that the cryptography processor is made so that it cannot be reprogrammed by any attacker.

But the disadvantage of this method is lacking two-sided authentication, that's why this authentication method is vulnerable—an attacker could break into the connection between the user and the server. The goal of this invention is creating a method of securing a safe zone for information being protected from unsanctioned use, allowing to heighten the safety level during the communication of the user and the person helping him.

Technical result means heightening the safety level during the user authentication and organizing the connection between the user and the assisting person. The technical result is achieved this way—in the known method of protecting information from unsanctioned use, characterized by forming with a closed cryptographic key and with a processor a data package stored in the user's device, including a single-use code of user identification, sending the data package to the server of the person aiding the client, deciphering the data package on that server and checking the single-use code of user authentication on the server. Data package consists of encrypted and non-encrypted parts, the non-encrypted part containing verification code, made with a possibility of checking the integrity of the whole data package, and also user identifier; and data package decryption on the aiding person's server is accomplished with the help of the cryptographic key, connected with the closed cryptographic key of the user's device and stored on the aiding person's server. In case of the positive result the user gets data package with the answering information, encrypted by the server processor with the cryptographic key, including the single-use code of user authentication, and in case of a negative result of verification, the aiding person's server will send the user an encrypted data package, containing error code, after that the user with the processor and the closed cryptographic key deciphers the data package, received from the server, and forms a new data package to send back, including a new single-use user authentication code.

It is rational to include the user ID, verification code, made so as to verify the package data integrity into the data package, also with the information concerning the given service. It is preferable to accomplish the verification of the single-use authentication code of the user with the aid of the data base of already used single-use authentication codes, and in case of matching user's single-use authentication code with the one in the base, to send the user an error code. It is also advisable to form a verification code, made with a function allowing checking the data package integrity with a hash function.

It is recommended to provide the encrypted data package with constant package verification, checked by the user's device and the aiding person's server. It is optimal to add the current geographical location and other meta-information to the encrypted part of the package.

It is advisable to make financial transactions as one of the services available. It is advisable to or services of selling goods in online stores as one of the services available. It is recommended to connect online stores with the user's device through the pay systems' servers. It is rational on the part of the pay systems to inform the user about the chosen goods, delivery address, payment sum, and banks, where there are the user's accounts. It is preferable on the part of the user to confirm receiving data and send the data package to the server of the paying system.

It is advisable for the person working with the server to record the results of connection with the user's device as notes in the data base. In this method the user's device could be made with an ability to biometrically verify the user's device. User's device could also be made with an ability to connect with the outer device to biometrically verify the user. In one of the methods of making the user's device could be done with an ability to store control biometrical sample of the user to identify the user.

It is preferable to use in that method the user's device, made as smart phone or a mobile phone, securing an ability to connect with a computer through the USB-cable. In one of the methods in making the user's device may be done as a module, fixed in a smart phone or a telephone. The sum of signs, presented in the definitive part of the independent point of the formula allows heightening the safety level at user authentication and organizing connection between the user and the person aiding him. So the encrypted part allows safely to transfer data from the device to the server and back through unprotected channels, and the un-encrypted part allows to identify the client and quickly check the integrity of the encrypted data package. In case of lacking client identification, server will look for an encryption key by method of searching, trying to decipher with all the existing keys in the system following verification. In case of lacking the verification code of the package integrity in the unencrypted part it will be necessary to decipher the whole package to verify its' integrity, it will take additional time in case, if the package is transferred incorrectly, and also additional time, even in case the package is correct.

### BRIEF DESCRIPTION OF THE DRAWINGS

FIG. 1 represents a block-scheme of a device and a method; and

FIG. 2 represents an alternative embodiment of the block-scheme of the device and a method.

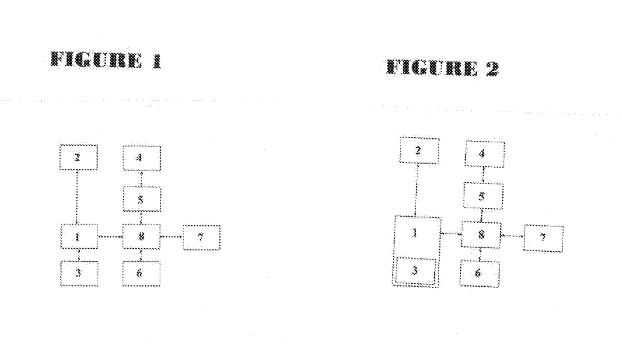

### DETAILED DESCRIPTION OF THE INVENTION

The device for protecting information from unsanctioned use with one of the ways of using the method consists of a cryptographic processor 1, connected to the way of storing closed cryptographic key 2, generating block of checking the single-use authentication codes 3 and control unit 8, which is connected to the in-out unit 5, made with an ability to connect with the aiding person's server 4, and also with the unit of user information input 6 and information display unit 7.

The unique trait of this way of working with the method with the above described device is that the attacker, breaking the stolen device, will not be able to extract information about the already used single-use passwords, which heightens safety of device usage. Method in the other way of use could be realized with a device, consisting of a cryptographic processor 1, connected to the way of storing closed cryptographic key 2 and control unit 8, which is connected to the in-out unit 5, made with an ability to connect with the aiding person's server 4, and also with the user information input unit 6, information display unit 7 and generating block of checking the single-use authentication codes 3.

The unique trait of this way of working with the method with the above described device is that the attacker, braking the stolen device, will be able to, after braking the stolen device, get the information about the already used single-use passwords, because it is stored in the non-volatile memory block unit, which, differently from the non-volatile memory block unit of the cryptographic processor, is not protected from such intrusion. But this way of making device is chipper to make.

A way of protecting the information from unsanctioned use in the preferable method is done like this. A user initiates the device (or activates the correspondent add on the device) and with the use of user information input unit 6 sends a signal to the control unit 8. Control unit 8 loads the necessary data from its' non-volatile memory to its' own memory and sends it to the information display unit 7, informing the user that the device is activated. Then the user with the aid of the ser information input unit 6 sends the chosen command to the control unit 8, which forms the data package for remote authentication on the aiding person's server (APS) 4 with the use of a single-use user authentication code (SUAC) and sends it to the cryptographic processor 1, which creates a new SUAC by extracting from the non-volatile memory of SUAC, changing it so that the changed SUAC could not be used during the forming the previous data packages, sends it to the non-volatile memory, excludes from the tool of storing the closed cryptographic key 2 a closed cryptographic key and using a closed cryptographic key encrypts the data package and sends it back to the control unit 8, which puts it into the memory unit and sends it to the in-out unit 6, which sends it to APS 4.

The data package, encrypted with the cryptographic processor 1, in the preferred method consists of information, referring to service, given to the user (for example, giving the bank the user's account balance or selling goods to the user from an online-store), SUAC, user identifier, hash sum, allowing to check the data package integrity, verification constantan, allowing the quick check the rightness of package decryption by comparing it with verification constantan, stored at the APS 4, apart from that, the additional hash sum could be added in the unencrypted way to the data package by the control unit 8, which allows to secure checking the integrity of the encrypted package without decrypting it.

Adding user identifier to the unencrypted part of the data package is necessary to secure correct way of searching for the corresponding key for deciphering the package on the server. Using the cryptographic processor 1 as a separate specialized processor allows to heighten the speed and reliability of encrypting data package because the specialized cryptographic processor deals with the encryption and decryption process quicker than the generic processor. Also the use of two processors heightens the general reliability and speed of the device, because it secures non-extracting of the closed encryption key from the device. A method of storing the closed cryptographic key 2 may be accomplished, also, as non-volatile memory.

Closed encryption key, used by the cryptographic processor 1, is recorded into the storage device of the closed encryption key 2 before transferring the device to the user and used in all the communication sessions with APS 4.

In this case the closed cryptographic key is unique for each device and made connected with a cryptographic key, stored at APS 4, which enables encryption and decryption of data packages, with which the user device and APS 4 share. Because while asymmetric encryption is used in this method, and both cryptographic keys are stored so that could not be extracted by the attacker, using one and the same closed encryption key in the user's device during a long time allows not to jeopardize the environment, created in this method.

Getting the data package, APS 4 checks the package integrity with the help of the hash sum, located in the non encrypted part of the package, identifies the user through user identifier, coded in the non encrypted part of the package, decrypts its' encrypted part with a cryptographic key, checks the integrity of the data package with verification constantan, included in the data package, checks user identification with the user identifier, located in the encrypted part of the package, checks the SUAC to verify that it was not used before, and in case of positive result offers the user a service he demanded for in the data package.

For that APS 4 forms data package, containing information about the required service, verification constantan, user identifier, SUAC, received after data package decryption, and also hash sum. Then this data package is encrypted by APS 4 using cryptographic key and is sent to the user. The same as with the data package sent by the user's device, in the preferred method, an additional hash sum for checking the encrypted part of the data package without decrypting at the user's device, and also user identifier are send by APS 4.

In case of a negative result of APS 4, it forms data package, which includes error code and hash sum, encrypts it with a cryptographic key and sends it to the user's device.

Error code allows the user device to identify the reason, why APS 4 refuses to grant the required service to the user: using incorrect SUAC, no user with the indicated in the data package identifier, incorrect has sum, incorrect verification constantan, or another error. After the data package received by the user's device after a successful check of the data package, sent by the user's device gets to the in-out unit 5 of the user's device, it is transferred to the control unit 8, where In the preferred method user identifier and hash sum are checked, then the encrypted part of the received data package is sent to the cryptographic processor 1, where it is decrypted with a closed cryptographic key, stored in the storage device of the closed cryptographic key 2.

The decrypted data package then is received by the control unit 8, where it is reviewed for compliance of the hash sum to the data package content and verification constata of that, which is written in the non-volatile memory, and also reviewed for compliance of the SUAC sent earlier by the user's device.

After that the information, sent by APS 4, is put to the information display unit 7 so the user could study it. In case of the negative result of checking control unit 8 forms a new data package, containing error code, new SUAC (sent also to the non-volatile memory), and hash sum, which is sent to the cryptographic processor 1 for encryption, after encryption—to the control unit 8, where it is preferably added by the non-encrypted hash sum and user identifier, then the data package is sent to the in-out unit 5 and then—to the APS 4.

It is possible to accomplish the stated method so that APS 4, in case of an error, along with the error code additionally generates single-use code of that error and adds it to the data package, sent to the user's device, after that the user's device checks that error single-use code, comparing it to the earlier used error single-use codes stored in the non-volatile memory, and puts it to the non-volatile memory.

In case if the sent error single-use code has not been seen before, the user's device processes data package, sent by APS 4, if the contrary—ignores it. This way of working with the stated method allows to rebuff the attackers who send the already used error codes to the device in order to block connection channel of APS 4 and the user's device by loading the user's device with false packages. In case if the data package sent by APS 4 contains error code, control unit 8 analyzes the error code and puts the error message to the information display unit 7 for the user to see. The is a way in which control unit 8, depending on the error code makes a few tries sending data package to APS 4, each time with a new SUAC, registered in the non-volatile memory.

In case the data packages exchange between the user's device and APS 4 is successful, a safe environment is created, excluding the possibility of an attacker braking into the connection channel. Then the user's device and APS 4 may continue to exchange data packages in the stated method, i.e. with encryption and exchange of SUAC. Also APS 4 in the preferred method notes the results of communication sessions with the user's device—making notes in the data base, which allows to implement a resources planning system by the person, rendering the service (like ERP, Enterprise Resource Planning).

In some ways of implementing this method one could use the user's device made with an ability to biometrically verify the user and connecting to the outer device of verifying the user, or the user's device could be made with an ability to store control biometrical sample of the user to identify him. It is possible to make a user's device as a smart phone or mobile phone, connected to the computer through USB-cable, or connected to the net of the company straight through the standard network connector, or as a module, implemented in the smart phone or phone, and connected to the remote receiver and transferring information to the screen.

As an example of this method one could examine a way to check the user account balance in a bank. In this case the user connects the device, made as a safe smart phone or such device zone to his computer, with a USB-cable. Then the device initializes and gives the user a menu for beginning work on its' screen.

After that the user chooses the “work online with the account”, the supplement on a smart phone connects to the safe zone inside the smart phone through the initiation of the remote authentication procedure, the safe zone shows the offer to the user on a trusted display to identify himself, by putting in a pin-code With the user input unit 6 or by making a biometrical authentication.

Then the procedure of remote authentication, accomplished by the control unit 8, generates the data package, consisting of the device identifier (which is flashed during the making of a safe environment; in this case it plays the role of user identifier), SUAC, done as a digit, increasing by one each time it is used, verification constata, operation identifier (such operation in this case is user authentication), collected into the sequence defined for this operation (algorithm of such collection is flashed during the making of the device), user identifier and data package hash sum are added in the beginning (without accounting for the hash sum field), this sequence is encrypted with a closed cryptographic key (which is placed in the storage device of the cryptographic key 2, made as a non-volatile memory during the making of the safe zone), then before the encrypted package there is put a device identifier and has sum of this data package (without accounting for hash sum field), after that such package is sent back to the control unit processor 8. Then the control unit processor 8 sends the data package through the USB-entry of the in-out unit 5 to the personal computer, adding URL of the bank server to it.

In this case the supplement on the computer receives the information about getting a data package and sends it with the in-out unit of the personal computer to the server of the bank in accordance with the URL.

After that the bank server accepts the data package, checks has sum, fixed in the package and has sum of the package itself (without accounting for the hash field). In case of positive result of checking the package, it is decrypted by the bank server according to the user identifier from the non-encrypted part of the package with the cryptographic key, which is associated on the bank server with the device identifier. Then the verification constata is checked, after which the has sum flashed in the data package is checked (without accounting for the hash sum field), then the SUAC check is made for uniqueness (for positive result of checking it is necessary that it is bigger than the last used SUAC).

In case of the positive result of all checking bank server forms a return data package, containing device identifier, SUAC, received during decryption of the data package from the user's smart phone, session number on the banking server, generated by the server, operation identifier On this case, it is “work with an account”), html-code, which will be given to the user, then before the package there is added a package has sum (without accounting for the hash sum field), the whole package is encrypted with the cryptographic key, in the beginning of the package there are added the device identifier field and hash sum of the formed data package (without accounting for the hash sum field), after that the package is sent to the in-out unit of the personal computer, whose supplement transfers the data package to the user's smart phone through USB, and the smart phone transfers the data package to the safe zone.

Processor of the control unit 8 compares the device identifier in the data package and the one which is flashed in the safe zone, checks the package has sum (without accounting for the hash sum field), then encrypts the data package with the cryptographic processor 1 and closed cryptographic key, stored in the storage device of the second cryptographic key 2, in the encrypted data package compares SUAC with the one sent earlier in the data package to the bank server, a decrypted data package is sent to the control unit processor 8 and from there—to the volatile memory, then the control unit processor 8 compares verification constata inside the package with the one stored in the non-volatile memory.

Then the control unit processor 8 compares the hash sum, written in the decrypted package, with the package hash sum (without accounting for the hash sum field), defines the operation identifier (in this case—“work with an account”) and forms data (decrypted html-code from the data package, for example, menu of work with an account) for showing it to the user on the information display unit 7, done as a safe display, after that the user continues work with the account with the described method.

In this case the user gets an opportunity to create and delete notes in the database of APS 4, and also to group the notes and give commands while working with his account (like “pay for all”, “pay for a group” or just “pay”).

The stated method of creating safe environment for protection information form unsanctioned use allows to heighten the safety of user authentication and the user connection channel with the person rendering the service.

1. A method of protecting information from unsanctioned use, the method comprising the steps of:
forming with the processor and closed cryptographic key, stored in a user's device, a data package, including a single-use authentication code,
sending data package to a server of the user and decrypting data package at the server of the user and checking at the server of the single-use authentication code, wherein the data package includes encrypted and non-encrypted parts, and the non-encrypted part includes a test code, made by checking the integrity of the whole package, and user identifier, and decrypting data package at the aiding person's server is accomplished with the cryptographic key, connected to the cryptographic key of the user's device and stored at the aiding person's server, and in case of positive result of verification the user gets a data package with the answering information, encrypted with the server processor and cryptographic key, including single-use authentication code of the user, and in case of a negative result of verification the aiding person's server sends the user data package, with the error code, after that the user with the processor and closed cryptographic key decrypts data package, received from the server, and forms a new data package to send, including new single-use code of user authentication.

2. The method as set forth in claim 1, wherein the data package contains user identifier, user authentication single-use code, test code, made with an ability to check data package integrity, and information, relating to the rendered service.

3. The method as set forth in claim 1, wherein the user authentication single-use code is accomplished through the data base of previously used user authentication codes and in case of matching a user single-use authentication code with the one in the base, send an error code to the user.

4. The method as set forth in claim 1, wherein the verification code, made with an ability to check the data package integrity is formed with a hash-function.

5. The method as set forth in claim 1, wherein the encrypted part of the data package has package verification constata, checked by the user's device and the aiding person's server.

6. The method as set forth in claim 1, wherein the encrypted part of the data package contains geographical location of the device and other meta-information.

7. The method as set forth in claim 1, financial operations are the service offered.

8. The method as set forth in claim 1, including the step of rendering online-stores selling goods services.

9. The method as set forth in claim 1, wherein the online-shops servers are connected with the user's device through the pay systems' servers.

10. The method as set forth in claim 1, wherein the pay systems servers send the user information about chosen goods, delivery address, payment sum and banks, where the user has accounts.

11. The method as set forth in claim 1, wherein the user confirms receiving data and sends data package to the server of the paying system.

12. The method as set forth in claim 1, wherein the aiding person's server registers the results of connecting to the user's device as notes in the data base.

13. The method as set forth in claim 1, wherein the user's device is equipped with an ability to biometrically verify the user's device.

14. The method as set forth in claim 1, wherein the user's device is made with an ability to connect with the outer user biometrical verification device.

15. The method as set forth in claim 1, wherein the user's device has ability to store control biometrical sample of the user for user identification.

16. The method as set forth in claim 1, wherein the user's device is made as a smart phone or mobile phone, with an ability to connect to the computer via USB-cable.

17. The method as set forth in claim 1, wherein the user's device is a module, installed in a smart phone or telephone.
